(19) United States
(12) Patent Application Publication
(10) Pub. No.: US 2013/0273515 A1
(43) Pub. Date: Oct. 17, 2013

(54) SYSTEM, METHOD AND APPARATUS FOR GENERATION OF LESSONS

(71) Applicants: James W. Voorhees, Vancouver, WA (US); Nathan P. Stahlman, Vancouver, WA (US); Aaron M. Purvis, Vancouver, WA (US)

(72) Inventors: James W. Voorhees, Vancouver, WA (US); Nathan P. Stahlman, Vancouver, WA (US); Aaron M. Purvis, Vancouver, WA (US)

(73) Assignee: INSTRUCTIONAL TECHNOLOGIES, INC., Vancouver, WA (US)

(21) Appl. No.: 13/447,706

(22) Filed: Apr. 16, 2012

(51) Int. Cl. G09B 5/00

(52) U.S. Cl. 434/350

(57) ABSTRACT

A system for creating a lesson by a client of training material includes a computer that is operatively interfaced to storage, in which, a plurality of frames are stored. Each of the frames has a component of training. Software running on the computer provides a lesson generation tool. The software provides for searching the plurality of frames to create a subset of the frames that correspond to a search criteria. The software further provides for selection, by the client, of a set of desired frames from the subset of the frames and the software creates a lesson that includes the desired frames.

### FIELD

This invention relates to the field of training and more particularly to a system for end-user lesson creation.

### BACKGROUND

Computer-based training is well known. Many learning institutions have quickly adopted various forms of computer-based training that provides courses and evaluate students using readily available computers.

Most training is provided in pre-defined lessons presented on a computer display, often known as computer-based training. After presenting a segment of content, questions are usually presented and responses are solicited from the target of the lesson (e.g. student, trainee) through keyboard or touch-screen inputs. A complete, beginning-to-end lesson is provided to the target of the lesson (e.g. a trainee or student) as a series of content, questions and responses. The lesson often follows a single theme or subject, providing content related to that subject. The lesson sometimes provides a quiz or test that evaluates the target's (e.g. student's) comprehension of the overall content. Often, the lesson repeats the presentation of the content when the trainee (e.g. student) does not demonstrate sufficient comprehension of the content as evidenced by a non-passing grade on the individual questions/responses or on the quiz/test.

Computer-based training is used in many learning situations including educational institutions, businesses, and government. One example is operator or driver training. Such training is often provided to new operators/drivers before the operator/driver has the opportunity to operate an actual vehicle. For example, before actually driving on roads with other drivers, high school students are often provided in-class training covering the basic fundamentals of operating an automobile. This training helps the new driver understand the operation of the target vehicle (e.g. how and when to turn on the lights, wipers, which pedal is the brake and which is the gas, etc.). Such training is often computer-based training with a fixed, scripted lesson. Each student that is taking driver education receives the same lesson and the lesson is often repeated until sufficient comprehension is achieved.

Similar lessons are often provided for remedial training. For example, after an accident or a moving violation, some states, including Florida, provide an opportunity for the driver involved in the incident to erase the accident or moving violation from their driving record by taking a remedial driver's educational course. This training is often offered as computer-based training and is often provided online (e.g. through the Internet). Such training has a fixed, scripted lesson. In such, the driver who made an illegal left turn and the driver who was ticketed for speeding are presented with the same scripted lesson.

Many professions offer computer-based training for operators of motor vehicles, boats, planes, trains, motorcycles, trucks, etc. This training typically consists of pre-scripted lessons progressing in an orderly fashion from basic principles and operation up to more complex subjects. For example, computer-based training for a truck driver begins with basic operation of the target vehicle and progresses to more the complicated aspects of operation, accident avoidance, operating under adverse weather, etc.

In the past, training was delivered in lessons based upon the client's needs. For example, the client (e.g. a trucking company) would specify and receive a complete beginner lesson for driving a particular truck. Such lessons are often pre-canned and the supplier delivers one or more complete lessons to the client (e.g. the trucking company) and the client delivers the lesson to the individual trainees. Additionally, in some situations, the training company issues a request for a training lesson to a supplier and the supplier plans and develops a lesson based upon the request. In general, though, the training company requests and receives a complete lesson and does not have the ability to create its own lesson.

Training lessons typically require major productions including graphics, actors, equipment, camera crews, animation, etc. Many providers of training lessons realize that it is better to divide the lesson into component segments referred to as “frames.” In this, the providers accumulate large numbers of frames, each concentrating on one particular subject, often running for only a few minutes. The providers then integrate multiple frames into a lesson and deliver the lesson to the training company or other end user.

What is needed is a system that will provide tools for creation of a lesson for use by an untrained administrator.

### SUMMARY

Many training systems contain portions of entire lessons (i.e., frames), typically stored as database records or individual files in a storage area. Typically, several of the frames are combined to form individual lessons, repeating frames across different lessons as needed. For example, a frame dealing with starting the engine is included in a basic lesson on starting the vehicle and also included in a more advanced lesson on starting a vehicle in cold weather, etc.

Having these frames available provides a basis for a system that provides a tool for a client. The tool permits searching of the frames for those of a desired subject matter and then the tool assembles the selected frames into a lesson. The client is now able to generate and tailor lessons to the needs of trainees.

In one embodiment, a training lesson generator is disclosed including a computer system that has access to storage with a plurality of frames located within the storage. Software running on the computer system provides a first user interface that allows searching and selecting one or more desired frames form the plurality of frames. The software running on the computer system combines the one or more desired frames into a lesson and saves the lesson in a file.

In another embodiment, a method of creating a lesson by a client of training material is disclosed. The method includes (a) storing a plurality of frames from a provider in memory accessible by a computer system. (b) The plurality of frames are searched for a subset of frames, by the client, using a lesson generation tool that runs on the computer system based upon a search criteria, the subset of frames related to the search criteria. (c) One or more related frames are displayed by the lesson generation tool. Next, (d) one or more desired frames are selected from the subset of frames by the client using the lesson generation tool, then (e) a lesson is created from the one or more desired frames by the lesson generation tool and (f) the lesson is saved for delivery to one or more trainees.

In another embodiment, a computer-based system for creating a lesson by a client of training material is disclosed. The computer-base system includes a computer that is operatively interfaced to storage, in which, a plurality of frames are stored. Each of the frames has a component of training. Software running on the computer provides a lesson generation tool. The software provides for searching the plurality of frames to create a subset of the frames that correspond to a search criteria. The software further provides for selection, by the client, of a set of desired frames from the subset of the frames and the software creates a lesson that includes the desired frames.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a computer-based training system.

FIG. 2 illustrates a pre-scripted course data relationship of a computer-based training system.

FIG. 3 illustrates a typical basic frame of a computer-based training system.

FIG. 4 illustrates a flow chart of a computer-based training system of the prior art.

FIG. 5 illustrates a basic flow of a lesson generator tool system.

FIG. 6 illustrates a flow chart of the lesson generator tool system.

FIG. 7 illustrates a schematic view of a typical computer as used in the lesson generator tool system.

FIG. 8 illustrates a schematic view of an exemplary content portion of a frame as used in the lesson generator tool system.

FIG. 9 illustrates a schematic view of an exemplary quiz portion of a frame as used in the lesson generator tool system.

FIG. 10 illustrates a schematic view of an exemplary user interface of the lesson generator tool system.

FIG. 11 illustrates a schematic view of a second exemplary user interface of the lesson generator tool system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

The described system pertains to any type of computer-based training for any target person or trainee. For brevity purposes, throughout this description, the target of the remedial training is directed to an exemplary trainee; a truck driver. The described system is equally applicable to any other trainee, including operators of other types of vehicles (cars, motorcycles, boats planes, fork-lifts, etc.), operators of practically anything such as machinery (CNC machines, cash registers, etc.), etc. The described system is anticipated to be used by a person in a client company (e.g. administrator) to create lessons for any given scenario from a set of frames.

For simplicity purposes, the following description uses, as an example, a truck driver as the target of the training. Truck drivers often receive computer-based training before operating a truck. Individual training companies often purchase complete lessons from providers of training lessons. As will be discussed, it is now possible for a person at the training company to develop lessons for their trainees using the disclosed tool and set of frames provided by the course material providers.

Throughout this description, “client company” refers to the end user company of the lesson generation system and “provider” refers to the company that provides the component segments and the tool to combine such into lessons.

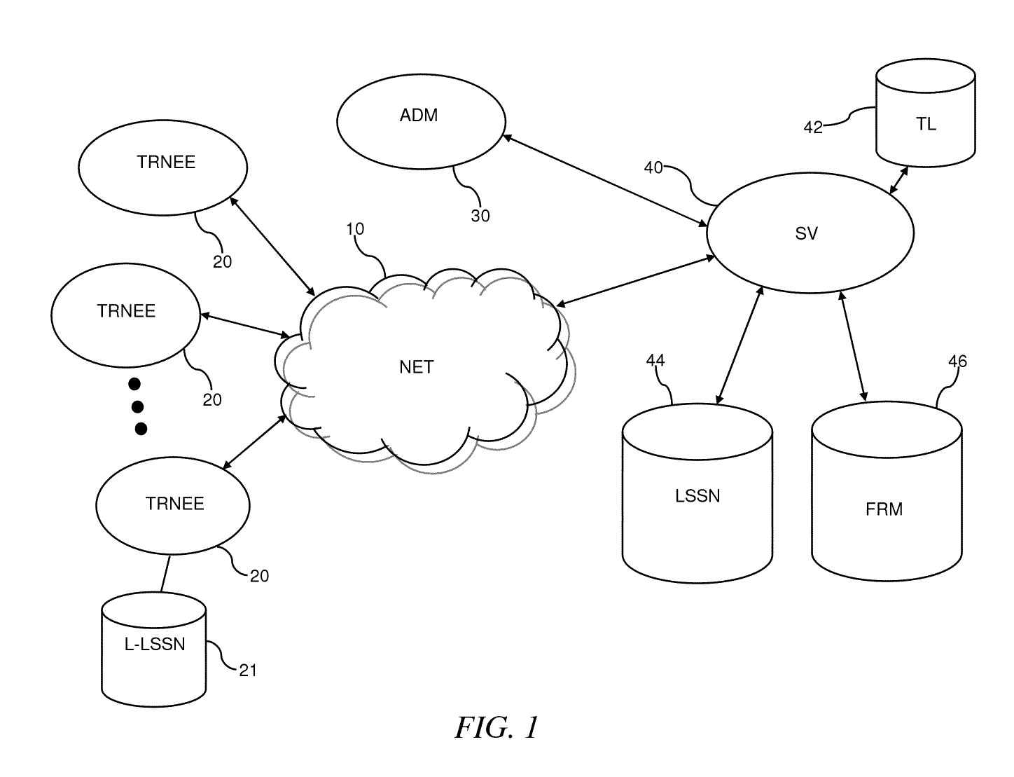

Referring to FIG. 1, a schematic view of a system of the lesson generation system is shown. The overall structure, communication paths, client-server architecture and data relationships shown are one example of a computer-based lesson creation system and are not meant to limit this disclosure in any way. Many different organizations and architectures are anticipated and included here within. The present invention is intended to operate with any known network 10, preferably operating with the Internet 10 (a.k.a. the World Wide Web). The present invention provides any number of end-user terminals 20 (e.g. personal computers at which a trainee is provided one or more lessons) with a system for computer-based training. The server 40 provides the services of creating the lessons 44 from the available frames 46 by staff 30 of the client company, delivering the lessons 44 to the end-user (e.g. trainee) terminals 20 and performing any billing/tracking, etc. The server system includes a lesson generation tool 42 for creation of one or more lesson 44. The lesson generation tool 42 has facilities for searching and selecting individual frames 46 from the frame library, combining and ordering the frames 46 into one or more lessons 44 and delivering/tracing the lessons 44. In alternate embodiments, the server 40 is a computer of the client company and the tool 42 and frames 46 are distributed to the client company from the provider company and loaded onto storage of the server 40 at the client company.

The lessons 44 are made up of several individual frames 46. A frame 46 provides a component of a lesson 44. In some embodiments, a frame 46 includes training on a single subject while in other embodiments, a frame 46 includes training on a few, minor subjects. Lessons are made by properly combining several frames 46 of a similar theme. For example, one lesson 44 consists of several frames 46 related to each other while another lesson 44 consists of some of the same frames 46 as well as other frames 46 of similar scope. For simplicity, we will describe each frames 46 as including content, quiz and descriptive data (e.g. metadata), although it is anticipated that the frames 46 include other optional components such as difficulty level, sequence data, cost data, repeat counts, etc. In as much, all possible frame 46 contents are included here within.

It is anticipated that any or all databases or storage areas 42/44/46 are locally interfaced to the server 20, remotely interfaced to the server 40 (e.g., Network Attached Storage—NAS) and/or remotely interfaced to the server 40 over a network, either a local area network or wide area network. Any computer-storage topology and network topology is anticipated and included here within.

In some example systems, after creation of one or more lessons 44 by the staff/administrator 30 using the lesson generation tool 42, the lesson 44 and the frames 46 needed for the lesson(s) 44 are downloaded (or mailed or emailed) to a client 20 and stored as a local lesson 21. In this example, the lesson(s) 44/21 are provided at the client terminal 20 without a need to be connected to the server 40 during delivery of the lesson 44/21. Therefore, at any time during the lesson(s) 44/21 or after the lesson(s) 44/21, it is anticipated that any accumulated data is uploaded to the server 40 for storage and analysis, as needed.

Although the clients 20 are shown as computers connected to the server 40 through the Internet 10, any known or future client 20 is anticipated such as a smart phone or tablet computer connected through the Internet 10 or through any network or combination of networks such as the cellular network, or alternately, terminals/computers are directly connected to the server 40, etc.

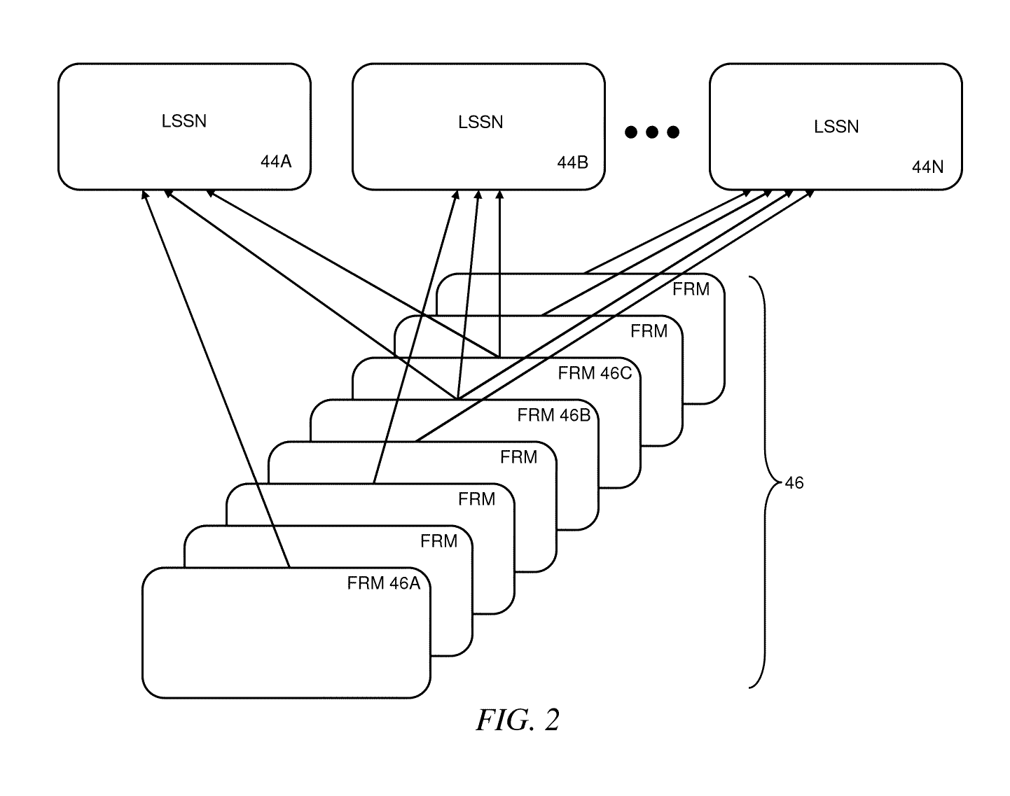

Referring to FIG. 2, a typical lesson 44 to frame 46 relationship of a computer-based training system is shown. This diagram shows the relationship between a plurality of individual frames 46 and a plurality of lessons 44A/44B/44N. As an example, a first lesson 44A includes frame 46A, frame 46B and frame 46C. In this example, frame 46B and 46C is also used in lesson 44B and frame 46B is also used in lesson 44N. Any combination and or order of frames 46 are anticipated as well as any number of frames 46 and lessons 44.

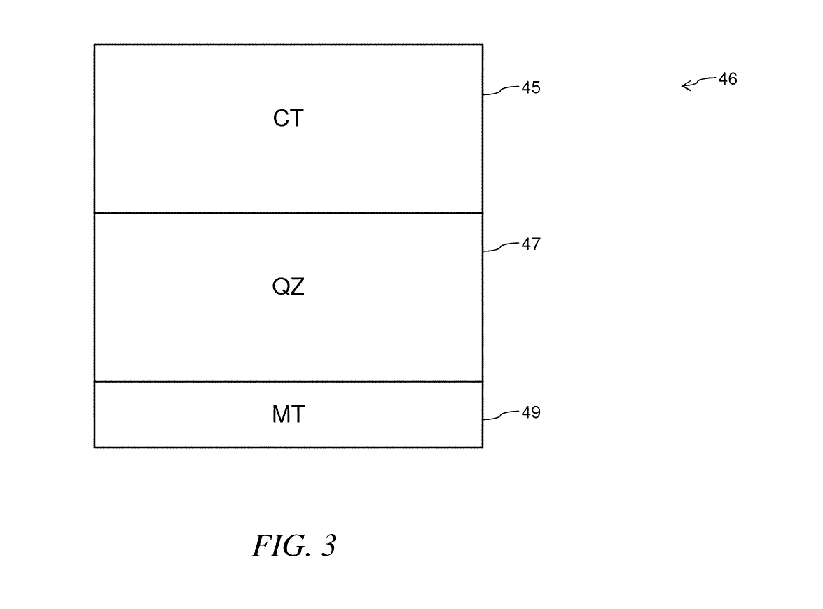

As shown in FIG. 3, as an example, each frame 46 consists of learning content 45, some sort of quiz or test 47 and, optionally, identification information or metadata 49. The learning content is presented in any known from such as computer graphics, animation, still images, video images, etc. In the exemplary frame 46 shown in FIG. 3, each frame 46 preferably provides a basic level of training on a given subject and provides a quiz or test 47 that is presented by the lesson 44. Responses to the quiz or test 47 are used to determine if the trainee has gained a sufficient understanding of the subject material (content) 45. In the prior art, the lesson 44 is created by, for example, the provider's script writer who, with the aid of the descriptive identification information or metadata 49, assembles multiple frames 46 into each lesson 44, providing an overall flow within the lesson. Once completed by the script writer, the lesson(s) 44 is delivered to the client.

Although shown as part of each frame 46, it is anticipated that the descriptive data 49 be stored/located in any location as known in the industry including as part of the file in which the frame 46 is stored, in an external file, in a secondary database, etc. As will be shown, the descriptive data 49 provides administrators with information to locate frames 46 that are related to a specific subject and to build lessons from the individual frames 46.

In the preferred embodiment, the metadata 49 is an index for cataloging/finding the frames 46, including, for example, one or more subjects, keywords, numerical values, etc. In the example shown in FIG. 3, the index is metadata 49 associated with each frame 46. For example, a frame 46 dealing with speeding has keywords stored in the metadata field 49 related to speed such as “speeding,” “gas pedal,” and “speed-limit.” In this, the metadata 49 is searchable for keywords and/or phrases within and by the lesson generation tool 42. Searching by the lesson generation tool 42 includes, for example, searching for keywords/phrases. It is anticipated that, in some embodiments, the keywords/phrases are pre-processed to provide common terminology. In other embodiments, other search strategies are anticipated including having a separate index file, each index pointing to one or more frames 46 or using a database, etc.

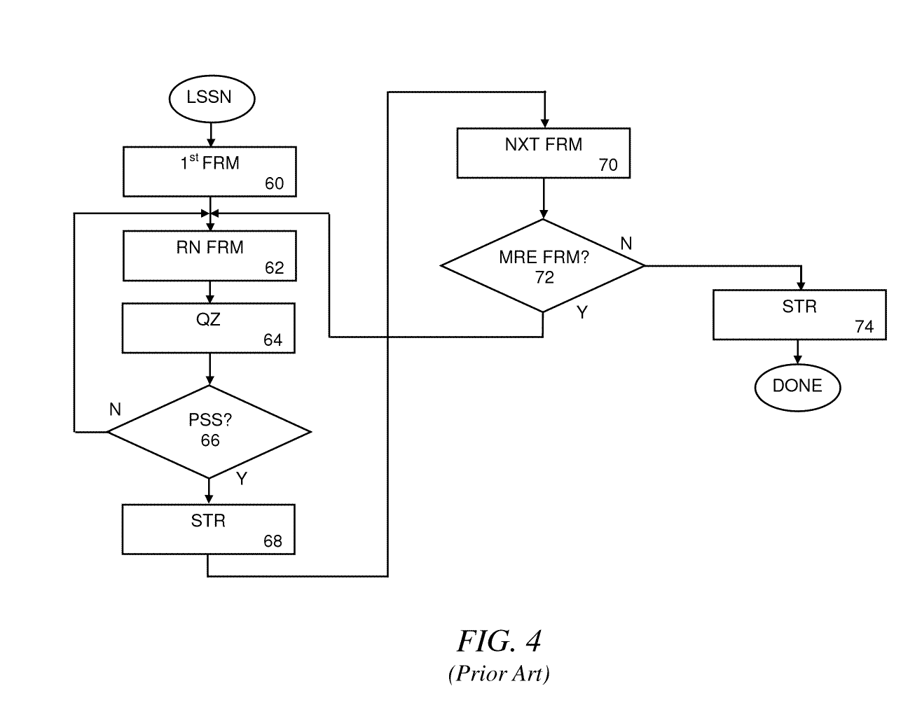

Referring to FIG. 4, a flow chart of a computer-based training system of the prior art is shown. In the prior art, the lessons 44 (see FIG. 1) previously created, for example, by the script writer is presented to the trainee. The first frame 46 (see FIGS. 1 and 2) of the lesson 44 is selected 60 and the content 45 (see FIG. 3) of the frame 46 is run/presented 62, presenting the content 45 of the subject to the trainee. Any form of content 45 presentation is anticipated, including flash frames, animation, still images, static text/graphic pages, imbedded text/video/audio, etc.

After presentation to the trainee, often, a quiz 47 (see FIG. 3) is presented 64 to ascertain how much was absorbed by the trainee. If the trainee does not demonstrate possession of enough knowledge 66 (e.g. does not pass 64 the quiz 47), the same frame 46 is re-run 62, re-presenting the content 45 of the subject to the trainee and quiz 47 is again presented 64 to ascertain how much was absorbed by the trainee. The above steps repeat until the trainee demonstrates possession of enough knowledge 66 and a next frame 46 from the lesson 44 is selected. In some prior art, results of the lesson 44 are stored 68 in a file related to the trainee. Such results often include the number of times the content 45 was repeated before a passing grade was achieved on the quiz 47, the length of time for each pass and the quiz 47 scores for each time the quiz 47 was taken.

Now, the next frame is selected 70. If there are no frames 46 remaining 72 in the lesson 44, results and/or completion records are optionally saved 74 and this training lesson 44 is complete. If there are remaining 72 frames 46 in the lesson 44, the above steps are repeated using the next frame 46.

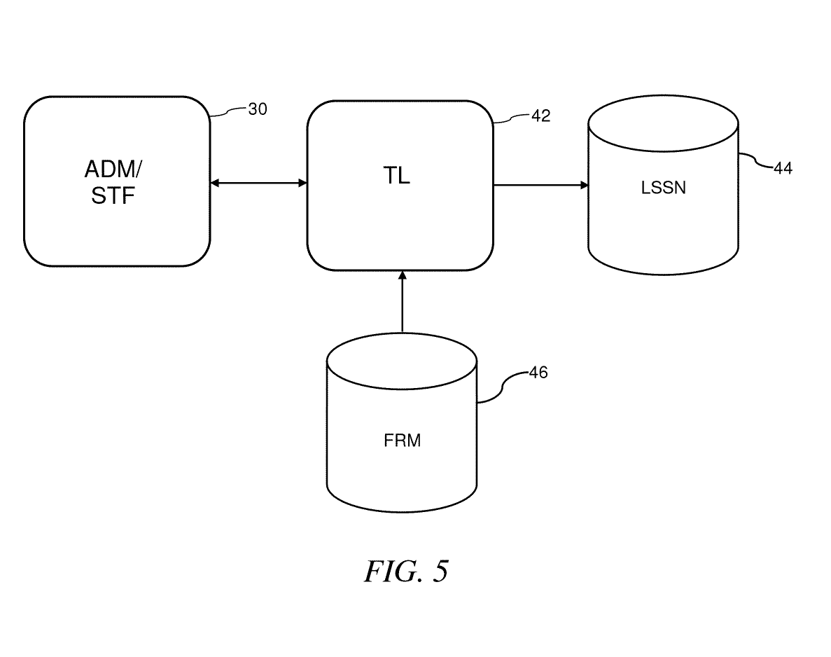

Referring to FIG. 5, a basic flow of a computer-based training system is shown. The client is provided with a set of frames 46 and a lesson generation tool 42 for creating one or more lessons 44. The administrator or staff personnel 30 of the client company interacts with the lesson generation tool 42 to locate and select the desired frames 46 for a new or modified lesson 44, interacting with the lesson generation tool 42. Once the desired frames 46 are selected, the administrator or staff personnel 30 operates the lesson generation tool 42 to save the lesson 44, preferably providing a meaningful name to the lesson 44 if it is a new lesson 44. The lesson generation tool 42 creates the proper script flow within the lesson 44 to present to content 45 of the frames 46, administer the individual quizzes 47, and manage the flow through the lesson 46, optionally based upon answers to the quizzes 47. In some embodiments, the frames 46 have non content 45 and only a quiz 47, providing for a test on overall comprehension of a macro subject, etc.

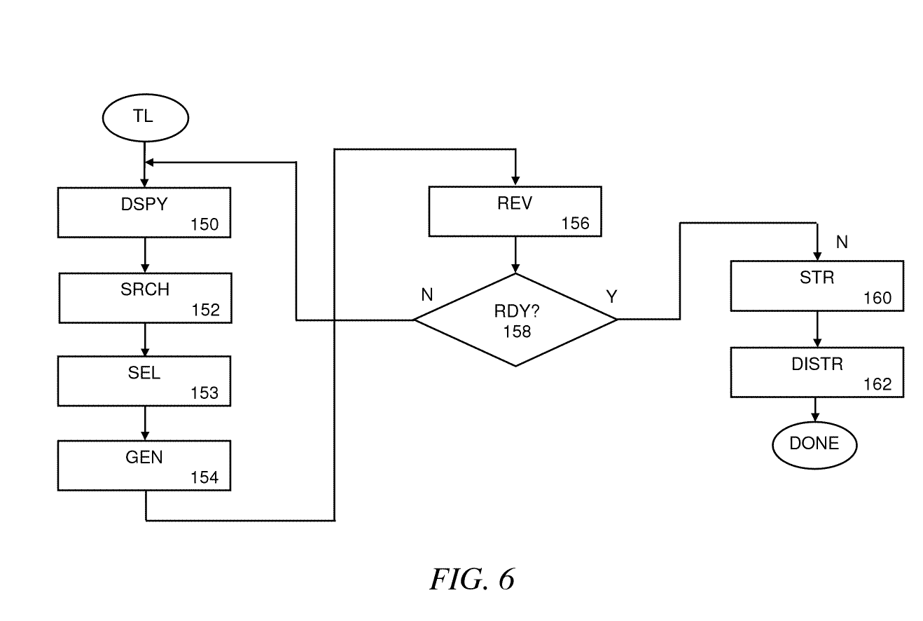

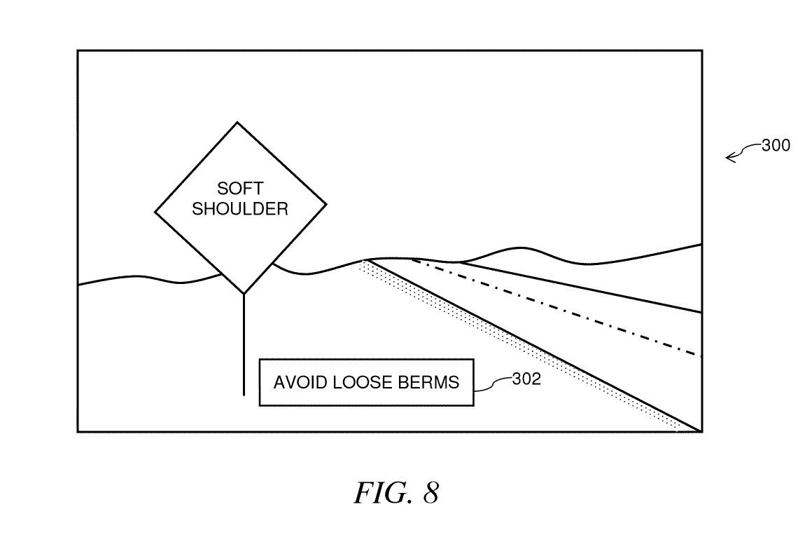

Referring to FIG. 6, an exemplary flow chart of a computer-based training system is shown. This flow chart is related to the display sequences shown in FIGS. 8 through 11.

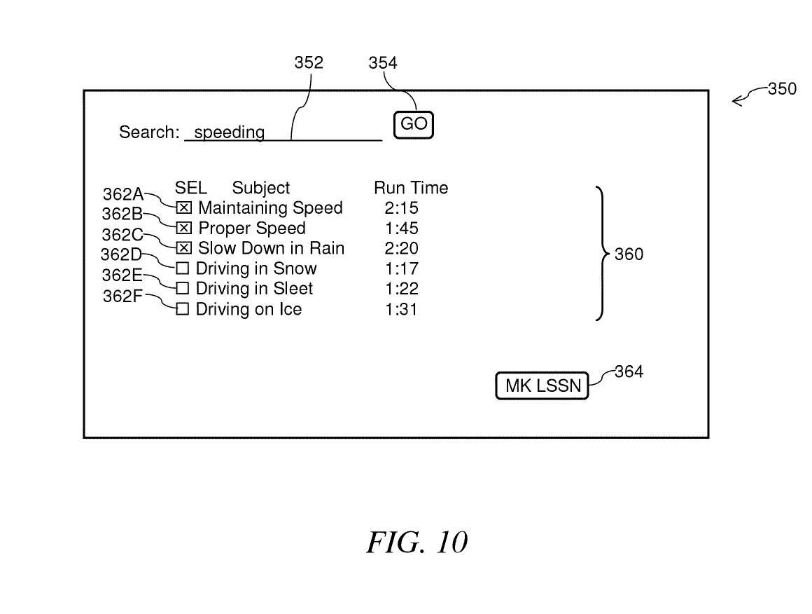

The first step is to display 150 a primary screen, describing the features of the lesson generation tool 42 and providing fields for data entry, initiation directives, and status displays. For example, the display step 150 presents a data entry field for “search” 352 (see FIG. 10) into which the staff person 30 enters criteria which is searched in the frames 46. Another example is a selection feature that, after the search is performed, the selection feature provides for selection of one or more frames 46 that are to be included in the created lesson 44.

After the staff person 30 enters criteria to be searched, a search of the frames 46 is performed 152 and the resulting matching frames 46 is displayed, as for example, the frames 360 related to speeding of FIG. 10. Now, the staff person 30 selects the desired frames 153, as shown in FIG. 10. In some embodiments, the staff person 30 is provided with a view or preview function that presents the found frames 350 for review. For example, by double clicking on the name of the frame 350, the content 45 of that frame 350 is run, either in normal speed, faster speed, an introduction segment, or any other summary of the content is displayed to aid in the proper selection of frames 46.

Once selection is complete, the staff person 30 directs the lesson generation tool 42 to create the lesson 44 and the lesson generation tool 42 generates 154 the lesson 44, including the script that controls flow through the individual frames 46 of the lesson 44. The staff person 30 is presented 156 with the lesson 44 (e.g., for review) and the lesson is optionally run, either in normal speed, faster speed, an introduction segment, or any other summary of the content, with or without the quizzes. If the staff person 30 is not happy 158 with the lesson 44 (e.g. it is missing something, is too long, has an inappropriate frame 46, etc.), the staff person 30 instructs the tool to go back to the display screen 150 and the currently selected frames 46 are displayed.

If the lesson 44 is ready 158, the staff person 30 instructs the lesson generation tool 42 to proceed and the lesson is stored 160 (preferably requesting a meaningful identifier/name from the staff person 30) and then distributed 162 for delivery of the training.

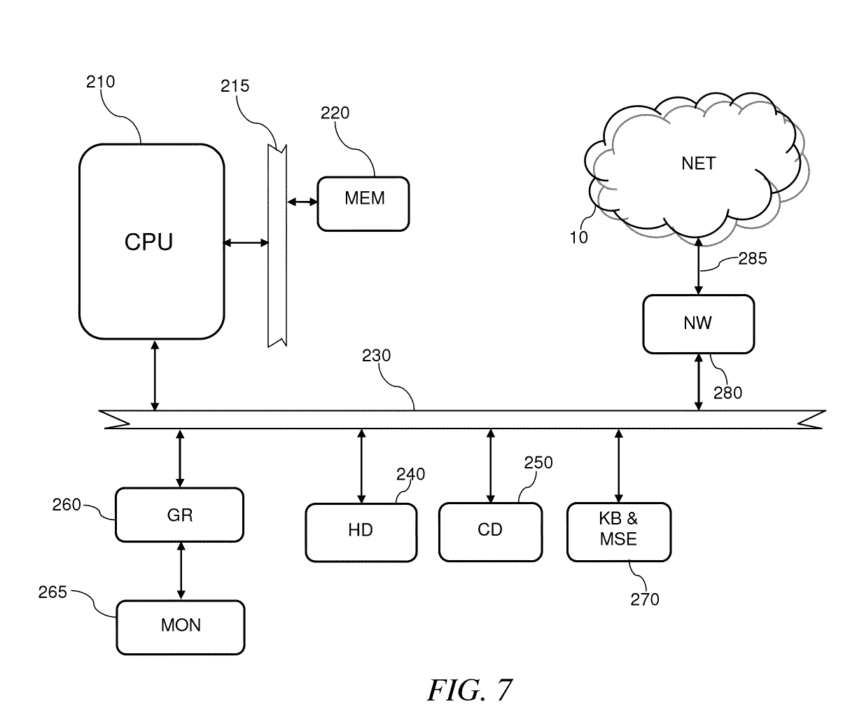

Referring to FIG. 7, a schematic view of a typical computer system of the present invention is shown. The example computer system represents a typical computer system used as the server 40 and/or the user terminal devices 20. The example computer system is shown in its simplest form, having a single processor. Many different computer architectures are known that accomplish similar results in a similar fashion and the present invention is not limited in any way to any particular computer system. The present invention works well utilizing a single processor system, as shown in FIG. 7, a multiple processor system where multiple processors share resources such as memory and storage, a multiple server system where several independent servers operate in parallel (perhaps having shared access to the data or any combination). In any of these systems, a processor 210 executes or runs stored programs that are generally stored for execution within a memory 220. The processor 210 is any processor or a group of processors, for example an Intel Pentium-4® CPU or the like. The memory 220 is connected to the processor by a memory bus 215 and is any memory 220 suitable for connection with the selected processor 210, such as SRAM, DRAM, SDRAM, RDRAM, DDR, DDR-2, etc. Also connected to the processor 210 is a system bus 230 for connecting to peripheral subsystems such as a network interface 280, a hard disk 240, a disk drive (e.g. DVD, CD) 250, a graphics adapter 260 and a keyboard/mouse 270. The graphics adapter 260 receives commands and display information from the system bus 230 and generates a display image that is displayed on the display 265.

In general, the hard disk 240 is used to store programs, executable code and data persistently, while the disk drive 250 is used to load CD/DVD/Blu-ray disk having programs, executable code and data onto the hard disk 240. These peripherals are examples of input/output devices, persistent storage and removable media storage. Other examples of persistent storage include core memory, FRAM, flash memory, etc. Other examples of removable media storage include CDRW, DVD, DVD writeable, Blu-ray, compact flash, other removable flash media, floppy disk, ZIP®, etc. In some embodiments, other devices are connected to the system through the system bus 230 or with other input-output connections/arrangements as known in the industry. Examples of these devices include printers; graphics tablets; joysticks; and communications adapters such as modems and Ethernet adapters.

The network interface 280 connects the computer-based system to the network 10 through a link 285 which is, preferably, a high speed link such as a cable broadband connection, a Digital Subscriber Loop (DSL) broadband connection, a T1 line, or a T3 line.

Referring to FIG. 8, a schematic view of an exemplary content portion of a frame 46 is shown, as used in a computer-based training system. The described system is not limited in any way to a particular format of content 45, sequence of content 45 and other portions of each frame 46, file layout, etc. The computer-based training system includes any known or future content presentation mechanism, the only requirement being that there are frames 46, each providing content 45 on a particular subject and, each optionally presenting a quiz 47 to determine if the trainee has grasped the particular subject. One exemplary content section 45 is shown in FIG. 8. In this content section 45 of a frame 46, a scene 300 is displayed along with a message 302. In this example, a road having a soft shoulder is displayed and the message informs the trainee that when driving on such roads, the trainee should avoid driving on the loose berms. In this example, the scene 300 is static and the message is a plain text message. Any known or future method of presenting content is anticipated including presenting the scene as computer graphics, still images, motion images, three-dimensional images, etc., and the optional message is, for example, displayed text, audio, etc.

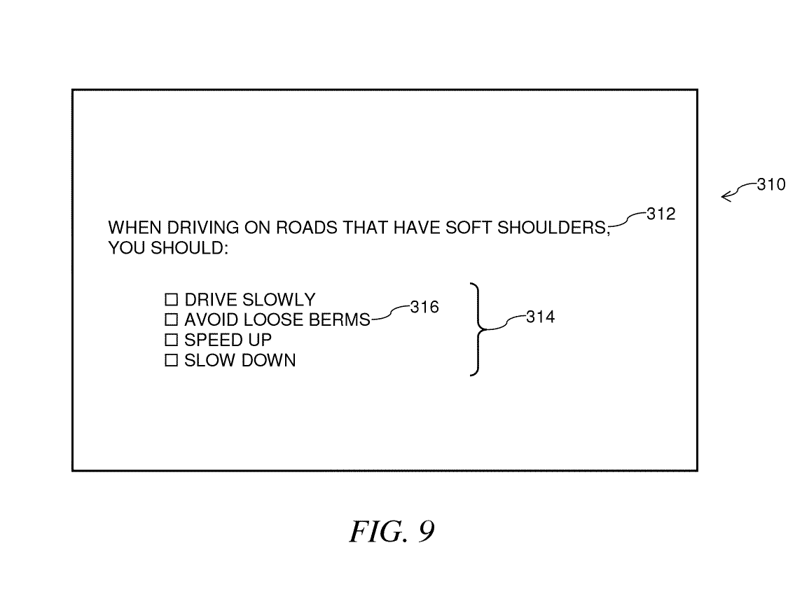

Referring to FIG. 9, a schematic view of an exemplary quiz portion of a frame 46 is shown, as used in a computer-based training system. The described system is not limited in any way to a particular format of quizzes 47, sequence of quizzes 47 and other portions of each frame 46, file layout, etc. The computer-based training system includes any known or future content presentation mechanism, the only requirement being that there are basic-level frames 46, each providing content 45 on a particular subject and, each optionally presenting a quiz 47 to determine if the trainee has grasped the particular subject. One exemplary quiz section 47 is shown in FIG. 9. In this quiz section 47 of an exemplary frame 46, a question/answer 310 is displayed having a question 312 and a plurality of possible answers 314 (i.e., multiple choices). This example relates to the content of FIG. 8. The correct answer is that the trainee should avoid driving on the loose berms 316. In this example, a question 312 and multiple possible answers 314 are provided as static text. Any known or future method of presenting a quiz 47 is anticipated including still images, motion images, three-dimensional images, displayed text, audio messages, etc. Any form of quiz 47 is anticipate including, but not limited to, multiple choices, fill-in-the-blank, essay, click on the correct object, etc. In some embodiments, the quiz 47 includes any of audio, text, images, video, 3-D images, etc. Any number of quiz questions/answers is anticipated in any given quiz 47.

Referring to FIG. 10, a schematic view of an exemplary user interface 350 of the lesson generator tool system is shown. In this example, a user interface of the lesson generator tool system has a data entry field into which the staff person 30 enters a search criteria 352. In the example, the word “speeding” has been entered into the search criteria and the “GO” function 354 was executed, thereby searching all of the frames 46 for occurrences of the word “speeding” (or optionally any grammatical or phonetic equivalents such as “speedy” or “sped”). The list of frames that were found is shown with a selection box 362A-F for each, a subject of each and a run time for each 360. Note, this is an example of a typical user interface and many other similar and/or different user interfaces are anticipated with more or less information regarding each frame 46.

In some embodiments, there a feature is provided to preview any or all of the frames 360, for example, by double clicking on the name or subject of the frame 360.

In this example, the user has selected the first three frames 360 by clicking on the associated selection boxes 362A-362C. Now, when the user selects the Make Lesson box 364, the lesson generation tool 42 assembles the selected frames into a lesson 44 and stores the lesson 44 for later use.

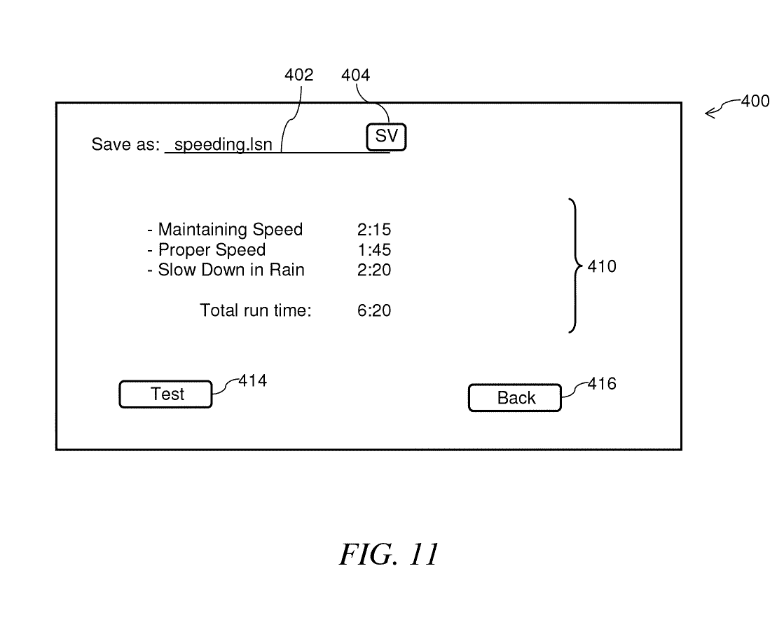

Referring to FIG. 11, a schematic view of a second exemplary user interface 400 of the lesson generator tool system is shown. In this example, after the Make Lesson function 364 of the first user interface screen of the lesson generation tool 42 has been evoked, the user is presented with the second user interface screen 400. This exemplary user interface has a list of frames 46 that were selected 410 and the total run time for the selected frames 46. Note, this is an example of a typical user interface and many other similar and/or different user interfaces are anticipated with more or less information regarding each frame 46.

In this example, the user is shown the three frames previously selected 410 and has the ability to save the frames into a lesson by entering a name for the lesson 402 (e.g. a file name). Now, when the staff person 30 selects the Save Lesson box 404, and the lesson generator tool 42 assembles the selected frames 46 into a lesson 44, including proper flow scripting, and stores the lesson 44 in the file name specified 402.

It is also anticipated that other features are provided such as a test feature 414 which will play the lesson 44 so the user can see how the selected frames 410 go together. In this example, there is a “back” feature 416 which will return to the selection user interface 350 so that the user is able to add/delete frames from the list 360.

In the past, the providers charged the client companies a monthly fee per lesson. With the lesson generator tool 42, the client is free to create as many lessons 44 as needed, even customizing individual lessons to match the need of a single trainee. Although it is anticipated that a feature of the lesson generator tool 42 is a billing feature (e.g., billing records are generated and transferred to the provider each time a lesson is created and each time a lesson is deleted), it is anticipated that an alternate billing system be implemented. For example, instead of billing by the number of lessons 44, a monthly fee is imposed on each trainee or potential trainee. This monthly fee covers the full set of frames 46 and any number of lessons 44 generated and maintained by a staff person 30 of the client using the lesson generator tool 42. For example in a client company that has a fleet of trucks and a number of drivers, the provider charges $3 per driver each month. So, if a client company has 100 drivers, they are charged $300 per month, independent of how many lessons 44 are generated using the lesson generator tool 42 and how many times the lessons 44 are run.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A training lesson generator comprising:
a computer system having access to storage;
a plurality of frames located within the storage, each frame having a component of training;
software running on the computer system providing a first user interface that allows searching and selecting one or more desired frames form the plurality of frames; and
software running on the computer system combines the one or more desired frames into a lesson and saving the lesson in a file.

2. The training lesson generator of claim 1, wherein the user interface further provides for previewing the desired frames after selection.

3. The training lesson generator of claim 1, wherein the user interface further provides for previewing the lesson before saving the lesson in the file.

4. The training lesson generator of claim 1, wherein the software running on the computer system inserts scripting into the lesson, the scripting provides the proper flow between the frames of the lesson.

5. The training lesson generator of claim 1, wherein the client is charged a monthly fixed fee per trainee for use of the training lesson generator and the plurality of frames.

6. A method of creating a lesson by a client of training material, the method comprising:
(a) storing a plurality of frames from a provider in memory accessible by a computer system;
(b) searching the plurality of frames for a subset of frames by the client using a lesson generation tool that runs on the computer system and using a search criteria, the subset of frames related to the search criteria;
(c) displaying one or more related frames by the lesson generation tool;
(d) selecting one or more desired frames from the subset of frames by the client using the lesson generation tool;
(e) creating a lesson from the one or more desired frames by the lesson generation tool; and
(f) saving the lesson for delivery to one or more trainees.

7. The method of claim 6, wherein the step of creating adds scripting to the lesson to control the flow of the lesson between the desired frames.

8. The method of claim 6, further comprising a step of (b′) comprising previewing one or more of the subset of frames by the lesson generation tool.

9. The method of claim 8, wherein the preview includes presenting the content portion of the one or more of the subset of frames.

10. The method of claim 8, wherein the preview includes presenting the content portion of the one or more of the subset of frames in fast motion.

11. The method of claim 8, wherein the preview includes presenting an introduction scan of the content portion of the one or more of the subset of frames.

12. The method of claim 8, further comprising a step of (e′) comprising previewing the lesson by the lesson generation tool.

13. A computer-based system for creating a lesson by a client of training material, the computer-base system comprising:
a computer;
storage operatively interfaced to the computer;
a plurality of frames stored within the storage, each of the frames having a component of training;
software running on the computer system providing a lesson generation tool, the software providing for searching the plurality of frames to create a subset of the frames that correspond to a search criteria, the software providing for selection by the client of a set of desired frames from the subset of the frames and the software creating a lesson that includes the desired frames.

14. The computer-based system for creating a lesson by the client of training material of claim 13, wherein the software running on the computer system adds scripting to the lesson to control the flow of the lesson between the desired frames.

15. The computer-based system for creating a lesson by the client of training material of claim 13, wherein the software running on the computer system presents a preview of one or more of the subset of frames by the lesson generation tool.

16. The computer-based system for creating a lesson by the client of training material of claim 15, wherein the preview includes presenting the content portion of the one or more of the subset of frames.

17. The computer-based system for creating a lesson by the client of training material of claim 15, wherein the preview includes presenting the content portion of the one or more of the subset of frames in fast motion.

18. The computer-based system for creating a lesson by the client of training material of claim 15, wherein the preview includes presenting an introduction scan of the content portion of the one or more of the subset of frames.

19. The computer-based system for creating a lesson by the client of training material of claim 13, wherein the software running on the computer system presents a preview of the lesson.

20. The computer-based system for creating a lesson by the client of training material of claim 13, wherein the software running on the computer system searches metadata associated with the plurality of frames to create the subset of the frames that correspond to the search criteria.
